(19) United States
(12) Patent Application Publication
(10) Pub. No.: US 2016/0363500 A1
(43) Pub. Date: Dec. 15, 2016

(54) SYSTEM AND METHOD FOR IMPROVING PRESSURE TEST EFFICIENCY

(71) Applicant: INNOVATIVE PRESSURE TESTING, LLC, Fulshear, TX (US)

(72) Inventors: Charles M. FRANKLIN, Katy, TX (US); Richard A. CULLY, Katy, TX (US)

(73) Assignee: Innovative Pressure Testing, LLC, Fulshear, TX (US)

(21) Appl. No.: 15/107,193

(22) PCT Filed: Jan. 23, 2015
(86) PCT No.: PCT/US2015/012712

§ 371 Date: Jun. 22, 2016

(51) Int. Cl. G01L 19/08; G01M 3/02

(52) U.S. Cl. CPC G01L 19/083; G01M 3/02

(57) ABSTRACT

A system includes a memory and a processor coupled to the memory. The processor receives a description of a pressure system, including a plurality of components to be tested, where each component has a required test pressure. The processor generates a first test sequence that tests the required test pressure of each of the plurality of components, where the first test sequence includes a first number of steps. The processor also iteratively generates a second test sequence that tests the required test pressure of each of the plurality of components, where the second test sequence comprises a second number of steps. The processor stores a representation of at least one of the first test sequence and the second test sequence in the memory, and the second number of steps is less than the first number of steps.

### BACKGROUND

Tubes, valves, seals, containers, tanks, receivers, pressure vessels, pipelines, conduits, heat exchangers, and other similar components, are typically configured to retain and/or transport fluids under pressure. These components may be referred to as a pressure system. One example of a pressure system includes a pipeline for transporting natural gas or other hydrocarbons. Another example is a natural gas well, an oil well, or other types of wells, whether being actively drilled or already producing, that typically transports fluids from a producing geological formation to a well head. Wells may include various components, such as a Christmas tree, a well head, production tubing, casing, drill pipe, blowout preventers, completion equipment, coiled tubing, snubbing equipment, and various other components.

The fluids retained or transported within pressure systems typically include one or more gases, liquids, or combinations thereof, including any solid components entrained within the fluid. A typical fluid may comprise crude oil, methane or natural gas, carbon dioxide, hydrogen sulfide, natural gas liquids, water, drilling fluid, and the like. Other examples include hydraulic fluid within a hydraulic line.

Many pressure systems are tested to ensure that the pressure system is not leaking and that the pressure system is capable of maintaining pressure integrity. However, pressure systems often include a number of components such as valves, conduits, chokes, blowout preventer (BOP) rams, BOP annulars, and other BOP components, which may have different test pressures (i.e., a pressure to which a component must be tested to assure its suitability for use in a given pressure system) and require more than one side of the component to be tested. Typically, not all components can be tested in a single test due to multiple sides needing to be tested, the isolation of certain components that results from another component being closed off, and the like. Thus, many tests may be required to suitably test all components of a pressure system. Further, the testing process is costly because tests may take from 12 to 24 hours to complete and an offshore drilling vessel or rig leases for $800,000 per day, for example.

### SUMMARY

The problems noted above are solved in large part by a system that includes a memory and a processor coupled to the memory. The processor receives a description of a pressure system, including a plurality of components to be tested, where each component has a required test pressure. The processor generates a first test sequence that tests the required test pressure of each of the plurality of components, where the first test sequence includes a first number of steps. The processor also iteratively generates a second test sequence that tests the required test pressure of each of the plurality of components, where the second test sequence comprises a second number of steps. The processor stores a representation of at least one of the first test sequence and the second test sequence in the memory, and the second number of steps is less than the first number of steps.

The problems noted above may be further solved by a method that includes receiving a description of a pressure system, including a plurality of components to be tested, where each component has a required test pressure. The method also includes generating a first test sequence that tests the required test pressure of each of the plurality of components, where the first test sequence includes a first number of steps, and iteratively generating a second test sequence that tests the required test pressure of each of the plurality of components, where the second test sequence includes a second number of steps. The second number of steps is less than the first number of steps.

The problems noted above may also be solved by a non-transitory computer-readable medium containing instructions that, when executed by a processor, cause the processor to receive a description of a pressure system, including a plurality of components to be tested, where each component has a required test pressure. The processor also generates a first test sequence that tests the required test pressure of each of the plurality of components, where the first test sequence includes a first number of steps, and iteratively generates a second test sequence that tests the required test pressure of each of the plurality of components, where the second test sequence includes a second number of steps. The processor stores a representation of at least one of the first test sequence and the second test sequence in a memory, and the second number of steps is less than the first number of steps.

### BRIEF DESCRIPTION OF THE DRAWINGS

For a detailed description of exemplary embodiments of the disclosure, reference will now be made to the accompanying drawings in which:

FIG. 1 shows a block diagram of a pressure testing system in accordance with various embodiments;

FIG. 2 shows a flow chart of a method improving a pressure test in accordance with various embodiments;

FIG. 3A shows an exemplary pressure test of various components of a pressure system in accordance with various embodiments;

FIG. 3B shows a chart demonstrating component pressure test coverage in multiple test steps in accordance with various embodiments;

FIG. 4A shows an exemplary improved pressure test of various components in a pressure system in accordance with various embodiments; and

FIG. 4B shows another chart demonstrating improved component pressure test coverage in multiple test steps in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. When used in a mechanical context, if a first component couples or is coupled to a second component, the connection between the components may be through a direct engagement of the two components, or through an indirect connection that is accomplished via other intermediate components, devices and/or connections. In addition, when used in an electrical context, if a first device couples to a second device, that connection may be through a direct electrical connection, or through an indirect electrical connection via other devices and connections.

As used herein, the term “test pressure” refers to a pressure to which a component must be tested to assure its safety for use in a given pressure system.

As used herein, the term “test side” refers a side of a component that, due to its placement in a given pressure system, must be tested to hold a test pressure. For example, for a given pressure system, a two-way valve may have only one test side if it is only required to hold pressure from one direction or may have two test sides if it is required to hold pressure from both directions.

As used herein, the term “test step” refers to a test designed to test one or more components of a pressure system. In certain circumstances, the required test pressures for a particular component may change from a first test step to a second test step (e.g., as a result of testing different sides of the component in each step of the component).

As used herein, the term “test sequence” refers to a series of test steps designed to test a number of components of a pressure system. In certain circumstances, the required test pressures for a particular component may change from a first test sequence to a second test sequence (e.g., as a result of anticipated well pressure changing while drilling deeper).

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As explained above, many pressure tests may be required to suitably test every component in a pressure system. Further, these tests can be extremely costly due to the delays caused by testing. Thus, there is a need to improve the efficiency of testing complex pressure systems. Additionally, there is a need to provide assurance that a series of tests successfully tests all test sides of components to their required test pressures, which can be easily overlooked by a human planning a test sequence. To solve these and other related problems, reference is made to the following description and figures, which detail systems and methods for improving the efficiency of pressure testing a pressure system.

The pressure system may include various tubes, valves, seals, containers, vessels, heat exchangers, pumps, pipelines, conduits, blow-out preventer (BOP) components, and other similar components to retain and/or transport fluids through the pressure system. Pressure systems may also include a pipeline for transporting natural gas or other hydrocarbons or other fluids, blow-out preventers, various wells including casing and other completion components, hydraulic or fuel lines, fluid storage containers, and other types of systems for transporting or retaining fluids.

The pressure system may contain fluids such as gases, liquids, or combinations thereof, including any solid components entrained within the fluid. Examples of fluids include crude oil, methane, natural gas, carbon dioxide, hydrogen sulfide, natural gas liquids, and the like. Where the pressure system comprises an exploration oil or gas well, the fluids typically include drilling fluids, lost circulation materials, various solids, drilled formation solids, and formation fluids and gases.

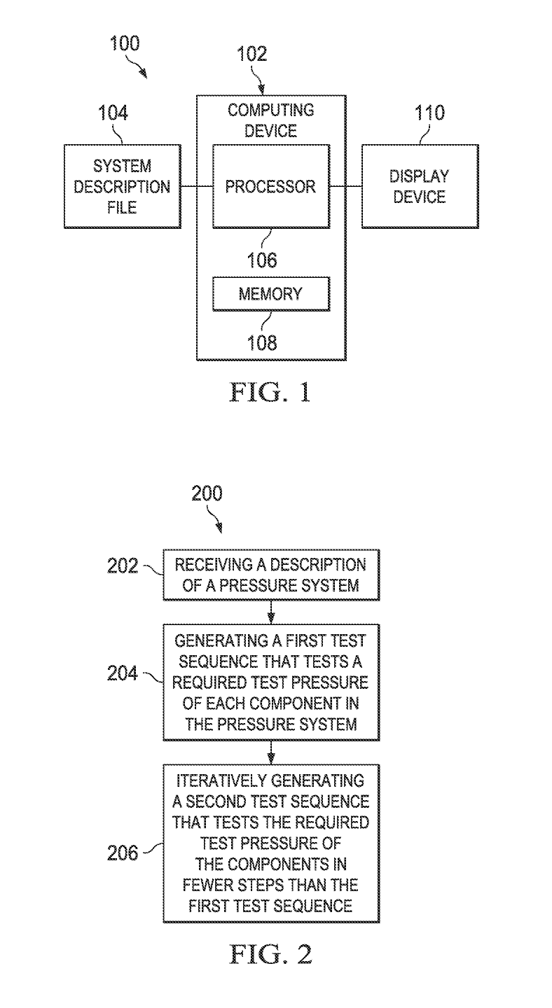

FIG. 1 shows a block diagram of a system 100 for improving the efficiency of pressure testing such a pressure system in accordance with various embodiments of the present disclosure. The system 100 comprises a computing device 102, which comprises at least a processor 106 coupled to a memory 108. The processor 106 may be a component in a variety of computers such as laptop computers, desktop computers, netbook and tablet computers, personal digital assistants, smartphones, and other similar devices and can be located at the testing site or remote from the site. One skilled in the art will appreciate that these computing devices include other elements in addition to the processor 106, such as display device 110, various types of storage (e.g., the memory 108), communication hardware, and the like. The present disclosure is not limited to any particular type of processor 106 or memory 108. The processor 106 may be configured to execute particular software programs to aid in the testing of a pressure system. The functionality of these programs will be described in further detail below.

As noted above, the processor 106 may couple to a display device 110, in some cases by way of intermediate hardware such as a graphics processing unit or video card. The display device 110 includes devices such as a computer monitor, a television, a smartphone display, or other known display devices.

The computing device 102 receives a pressure system description file 104 as an input. The pressure system description file 104 generally describes a pressure system, for example by way of its various interconnections, pathways, components, and characteristics associated therewith. For example, a simple pressure system description file 104 may specify a conduit coupling a first endpoint to a second endpoint, where a valve regulates flow in the conduit in between the endpoints. An example of a characteristic is that the valve is a two-sided valve and has a test pressure associated with a first side of the valve of 5,000 psi and a test pressure associated with a second side of the valve of 8,000 psi. Of course, real world pressure systems are often much more complex, but the pressure system description file 104 includes data sufficient to describe such complex pressure systems, including multiple nodes, interconnections, components, and characteristics (e.g., test pressures) of each portion of the pressure system.

In accordance with various embodiments, the processor 106 receives the pressure system description file 104 as input and, based on the pressure system specified by the file 104, generates a test sequence that includes test steps to adequately test each component of the pressure system. As will be understood and further explained below, in the context of a complex pressure system an initially determined test sequence, although sufficient to test each component to its rated pressure, may include more test steps than is truly necessary. For example, in a case where there are four components to be tested, the first test sequence may require a distinct test step to test each of the four components; that is, four test steps are needed. However, in many cases, particularly in complex pressure systems, more than one component may be tested in a single test step.

Thus, the processor 106 further generates a second test sequence that, similarly to the first test sequence, adequately tests each component of the pressure system. However, analysis of the pressure system may lead to a determination by the processor 106 that, for example, multiple components may be tested in a single step. For example, the first and third components may be tested in a first step while the second and fourth components are tested in a second step; that is, only two test steps are needed. In accordance with various embodiments, the processor 106 iteratively generates test sequences until an improvement in the test sequence is realized. The improvement may take the form of a reduction in the number of test steps required to test the components of the pressure system or, in some embodiments, an optimization of number of test steps required to test the components of the pressure system. As noted, the above improvement in the number of test steps in a test sequence is merely illustrative, and further examples will be explained more fully below. In a pressure system containing dozens or perhaps hundreds of various components, each of which needs to be tested to assure that the pressure system is capable of safe function, an improvement or reduction in the amount of test steps required to test each component saves valuable time in the field.

When the processor 106 has arrived at an improved or optimized test sequence, the processor 106 may store that test sequence to the memory 108 for further use in a test procedure. For example, a user of the system 100 may subsequently access the test sequence stored in memory 108 to review the test sequence or a test control program (not pictured) may access the stored test sequence in memory 108 to begin to implement the test sequence on a pressure system.

As explained above, the system 100 also includes a display device 110. In certain embodiments, the processor 106 may determine or verify that the test steps of a second or subsequent test sequence adequately test the required test pressure of each component in the pressure system. Once the processor 106 has validated that the required test pressure of each component is adequately tested by the sequence, the processor 106 may cause the display 110 to display an indication of verification. Alternate methods of verification output are within the scope of the present disclosure, such as an audible communication, a printed communication, or other similar communication to a user.

In certain embodiments, one or more various components of the pressure system may have more than one test side, such as a two-way valve that may experience a pressure differential in either direction. Further, the required test pressure may be different for each side of the component. In such embodiments, any test sequence generated by the processor 106 must test all sides of the component and to the required test pressure for either side. In certain embodiments, the test pressure for a first side of the component may differ from the test pressure for a second side of the component, and so forth. As discussed above, when the processor 106 causes the display 110 to display an indication of verification, such an indication communicates to a user that the test sequence adequately tests each side of each component of the pressure system.

In some cases, one of the test sequences generated by the processor 106 may cause a rated pressure of a component of the pressure system to be exceeded. Such a test sequence would not be appropriate to carry out, since the component could fail despite being functional to its rated test pressure. Thus, in the event that such a test sequence is generated, regardless of whether it is the final test sequence generated by the processor 106 that includes a reduced number of test steps relative to a first generated test sequence, the processor 106 generates a subsequent test sequence that eliminates the test step that caused the rated pressure of a component to be exceeded. In this way, as the processor 106 iterates through possible test sequences, it is ensured that a resulting next test sequence does not cause the rated pressure of any component to be exceeded. Further, in some embodiments, the processor 106 may cause the display 110 to display an indication that a particular test sequence has caused the rated pressure of one or more components to be exceeded, which may prompt user action or input if needed.

As referenced above, in some circumstances a user may desire to manually override or otherwise modify a test sequence. The processor 106 may receive such a request to alter a test step of any particular sequence. For example, a user may possess knowledge of environmental or situational circumstances that are unknown to the processor 106 and, based on this knowledge, desire to alter a particular test sequence. However, of course, the involvement of a human user in the planning of a test sequence introduces a potentially dangerous variable in that the pressure system being tested is complex, and minor errors by a user may be amplified during testing, potentially with negative consequences. Thus, in accordance with various embodiments, the processor 106 determines whether the user's override request causes a rated pressure of any component to be exceeded. If a rated pressure is exceeded, the processor 106 further causes the display device 110 or other output device (e.g., a speaker) to generate a warning indication. Ideally, in such a scenario, the user would take preventative action to avoid the condition that generated the warning. However, in some embodiments, the processor 106 may further cause the test sequence generation process to halt pending input of a validation code or other indication that the process is to continue. In this way, further prevention against human error is enabled and thus enhanced safety during pressure testing is ensured.

Turning now to FIG. 2, a method 200 is shown in accordance with various embodiments. The method 200 begins in block 202 with receiving a description of a pressure system. As explained above, such a description may be contained in a pressure system description files 104 that details the various nodes, interconnections, components, and characteristics (e.g., rated pressure) of a pressure system.

The method 200 continues in block 204 with generating a first test sequence that tests a required test pressure of each component in the pressure system. Often, the first test sequence contains more test steps than necessary to suitably test each component of the pressure system. Thus, the method 200 continues in block 206 with iteratively generating a second test sequence that tests the required test pressure of each component of the pressure system. The second or subsequent test sequence adequately tests the required test pressures using a fewer number of steps relative to the first sequence, thus reducing the time required to carry out the test. Further, while not explicitly shown in FIG. 2, it will be appreciated that the method 200 may include any additional functionality as is described herein. The scope of the present disclosure is not limited to only the steps explicitly shown in FIG. 2.

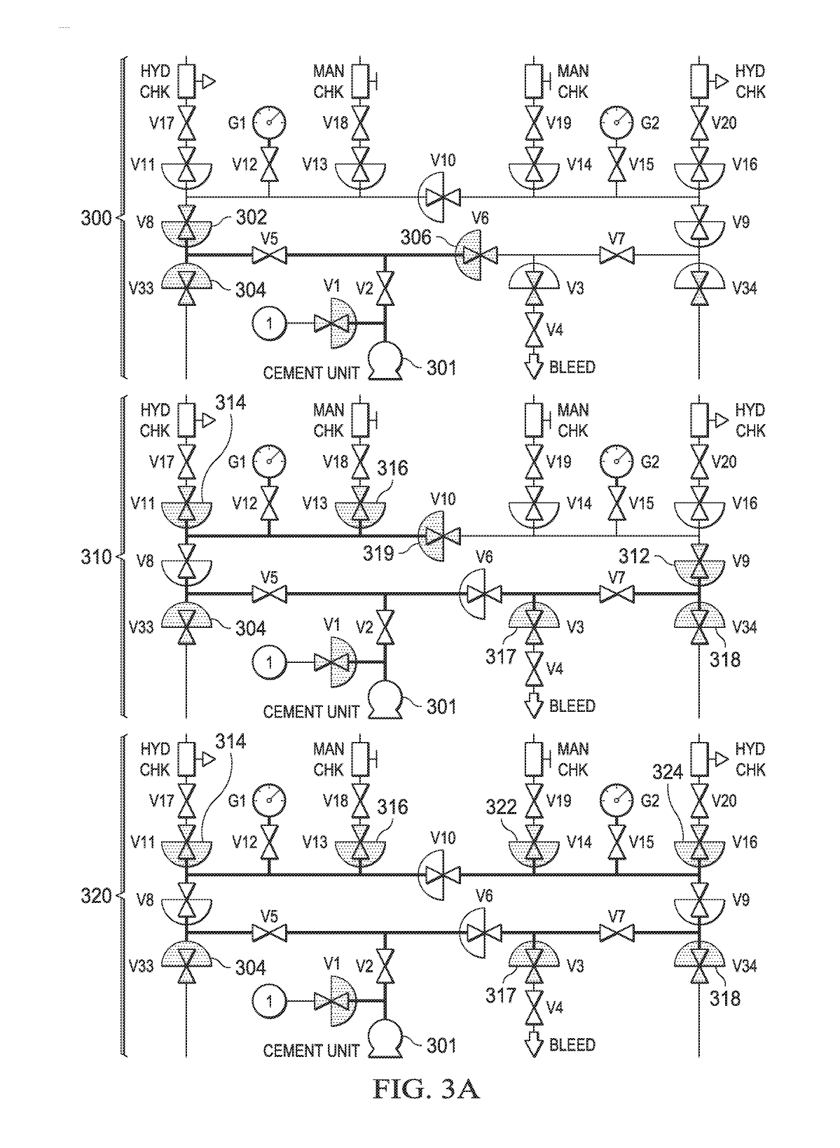

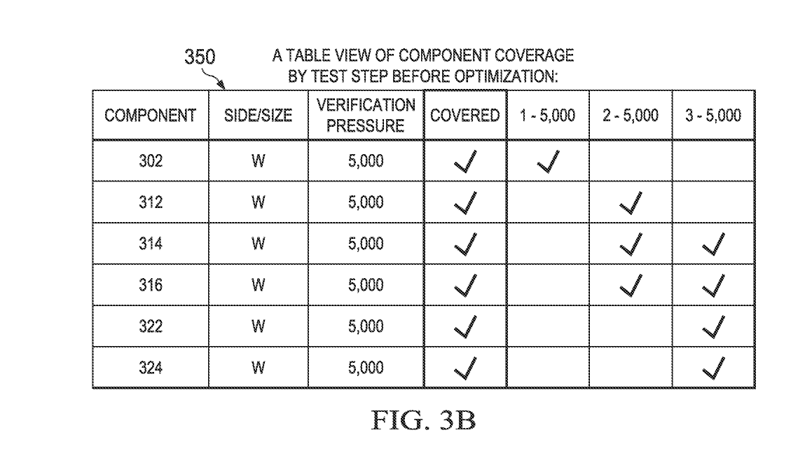

Turning now to FIG. 3A, an exemplary pressure test of various components of a pressure system is shown in accordance with various embodiments. The pressure test includes a first step 300, a second step 310, and a third step 320. In the first step 300, a cement unit 301 is used to pressurize a fluid in the pressure system. A valve 302 is being tested in the first step 300 and thus is closed. As shown, other valves 304, 306 are also closed, although these valves may have a higher required test pressure and thus are not being tested in test step 300.

In the second step 310, the cement unit 301 is similarly used to pressurize a fluid in the pressure system. Valves 312, 314, 316 are being tested in the second step 310 and thus are closed. Further, other valves 317, 318, 319 are also closed, although these valves may have a higher required test pressure and thus are not being tested in test step 310.

In the third step 320, the cement unit 301 is similarly used to pressurize a fluid in the pressure system. Valves 322, 324 are being tested in the third step 320 and thus are closed. Further, other valves 304, 314, 316 (already tested) and valves 317, 318 are also closed, although these valves may have a higher required test pressure (or have already been tested) and thus are not being tested in test step 320.

FIG. 3B shows a chart 350 that demonstrates the pressure test coverage of components in multiple test steps 300, 310, 320 of FIG. 3A in accordance with various embodiments. That is, the valve 302 was tested in the first step 300; the valves 312, 314, 316 were tested in the second step 310; and the valves 322, 324 were tested in the third step 320. Further, although shown as having the same required test pressure, it should be appreciated that each valve may have a different required test pressure, and test steps may be generated by the processor 106 to take this into account. The test sequence described in FIGS. 3A and 3B may be in some cases analogous to a first test sequence, which has not been subject to further improvement.

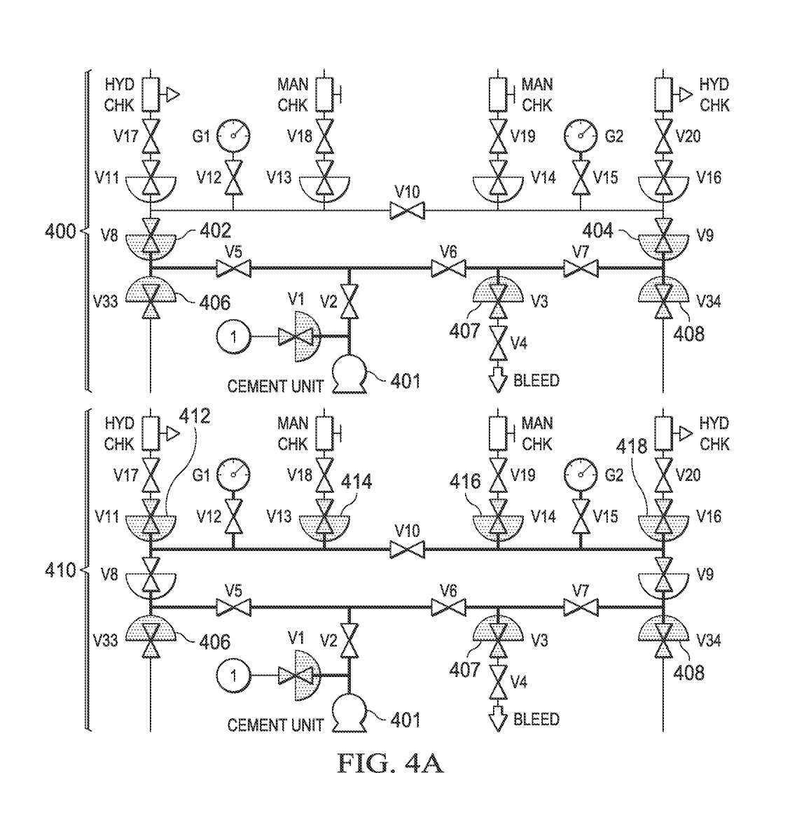

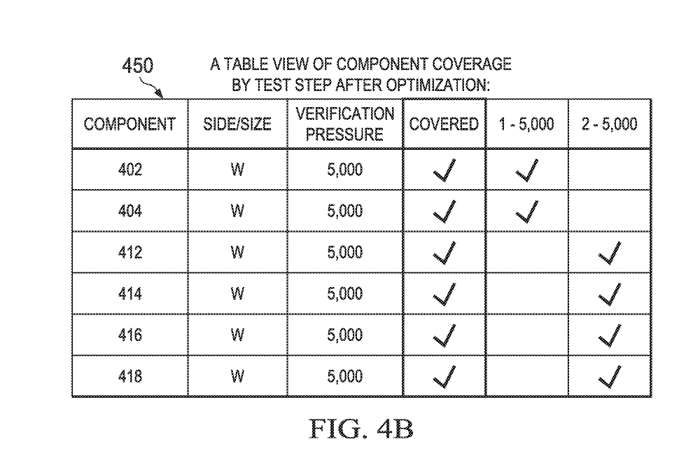

Turning now to FIGS. 4A and 4B, an exemplary pressure test of various components of a pressure system is shown in accordance with various embodiments, where the number of test steps is reduced as compared to FIGS. 3A and 3B. The pressure test in FIGS. 4A and 4B includes a first step 400 and a second step 410.

In the first step 400, a cement unit 401 is used to pressurize a fluid in the pressure system. Valves 402, 404 are being tested in the first step 400 and thus are closed. As shown, other valves 406, 407, 408 are also closed, although these valves may have a higher required test pressure and thus are not being tested in test step 400.

In the second step 410, the cement unit 401 is similarly used to pressurize a fluid in the pressure system. Valves 412, 414, 416, 418 are being tested in the second step 410 and thus are closed. Further, other valves 406, 407, 408 are also closed, although these valves may have a higher required test pressure and thus are not being tested in test step 410. As above, it may also be the case that valves 406, 407, 408 have already been tested. It should be understood of course that these descriptions are merely exemplary, and various pressure systems may contain many more or less components than what is presently illustrated.

FIG. 4B shows a chart 450 that demonstrates the pressure test coverage of components in multiple test steps 400, 410 of FIG. 4A in accordance with various embodiments. That is, the valves 402, 404 were tested in the first step 400; the valves 412, 414, 416, 418 were tested in the second step 410. It will be appreciated that the pressure systems of FIGS. 3A and 4A are the same; thus, FIG. 4A represents an improvement or reduction in the number of test steps required to adequately test a number of components 402, 404, 412, 414, 416, 418. That is, the test sequence described in FIGS. 4A and 4B may be in some cases analogous to a second test sequence, where the number of test steps is reduced relative to the first test sequence shown in FIGS. 3A and 3B.

Referring briefly back to FIG. 1, the processor 106 is configured to execute instructions read from a non-transitory computer-readable medium, and may be a general-purpose processor, digital signal processor, microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. The memory 108 is one example of a computer-readable medium coupled to and accessible by the processor 106. The memory 108 may include volatile and/or non-volatile semiconductor memory (e.g., flash memory or static or dynamic random access memory), or other appropriate storage media now known or later developed. Various programs executable by the processor 106, and data structures manipulatable by the processor 106 may be stored in the memory 108. In accordance with various embodiments, the program(s) stored in the memory 108, when executed by the processor 106, may cause the processor 106 to carry out various steps of the methods described above.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A system, comprising:
a memory; and
a processor coupled to the memory, the processor configured to:
receive a description of a pressure system, including a plurality of components to be tested, each component having a required test pressure;
generate a first test sequence that tests the required test pressure of each of the plurality of components, wherein the first test sequence comprises a first number of steps;
iteratively generate a second test sequence that tests the required test pressure of each of the plurality of components, wherein the second test sequence comprises a second number of steps; and
store a representation of at least one of the first test sequence and the second test sequence in the memory;
wherein the second number of steps is less than the first number of steps.

2. The system of claim 1 further comprising a display device coupled to the processor, wherein the processor is further configured to verify that the second test sequence tests the required test pressure of each of the plurality of components and, upon verification, cause the display device to display an indication of verification.

3. The system of claim 1 wherein at least one of the plurality of components comprises more than one test side and the first and second test sequences test the required test pressure for all test sides of the one of the plurality components.

4. The system of claim 3 wherein a required test pressure for a first test side is different than a required test pressure for a second test side.

5. The system of claim 1 wherein the first test sequence includes a step that causes a rated pressure of one of the components to be exceeded and wherein the second test sequence eliminates the step that causes the rated pressure to be exceeded.

6. The system of claim 1 further comprising a display device, wherein the processor is further configured to:
receive a manual override request that alters a step of either test sequence such that the step causes a rated pressure of one of the components to be exceeded; and
as a result of a determination that the rated pressure is exceeded, cause the display device to display a warning indication.

7. A method, comprising:
receiving, by a processor, a description of a pressure system, including a plurality of components to be tested, each component having a required test pressure;
generating, by the processor, a first test sequence that tests the required test pressure of each of the plurality of components, wherein the first test sequence comprises a first number of steps; and
iteratively generating, by the processor, a second test sequence that tests the required test pressure of each of the plurality of components, wherein the second test sequence comprises a second number of steps;
wherein the second number of steps is less than the first number of steps.

8. The method of claim 7 further comprising verifying, by the processor, that the second test sequence tests the required test pressure of each of the plurality of components and, upon verification, causing a display device to display an indication of verification.

9. The method of claim 7 wherein at least one of the plurality of components comprises more than one test side and the first and second test sequences test the required test pressure for all test sides of the one of the plurality components.

10. The method of claim 9 wherein a required test pressure for a first test side is different than a required test pressure for a second test side.

11. The method of claim 7 wherein the first test sequence includes a step that causes a rated pressure of one of the components to be exceeded and wherein the second test sequence eliminates the step that causes the rated pressure to be exceeded.

12. The method of claim 7 further comprising receiving, by the processor, a manual override request that alters a step of either test sequence such that the step causes a rated pressure of one of the components to be exceeded and, as a result of determining that the rated pressure is exceeded, causing a display device to display a warning indication.

13. A non-transitory computer-readable medium containing instructions that, when executed by a processor, cause the processor to:
receive a description of a pressure system, including a plurality of components to be tested, each component having a required test pressure;
generate a first test sequence that tests the required test pressure of each of the plurality of components, wherein the first test sequence comprises a first number of steps;
iteratively generate a second test sequence that tests the required test pressure of each of the plurality of components, wherein the second test sequence comprises a second number of steps; and
store a representation of at least one of the first test sequence and the second test sequence in a memory;
wherein the second number of steps is less than the first number of steps.

14. The non-transitory computer-readable medium of claim 13 wherein the processor is further caused to verify that the second test sequence tests the required test pressure of each of the plurality of components and, upon verification, cause a display device coupled to the processor to display an indication of verification.

15. The non-transitory computer-readable medium of claim 13 wherein at least one of the plurality of components comprises more than one test side and the first and second test sequences test the required test pressure for all test sides of the one of the plurality components.

16. The non-transitory computer-readable medium of claim 15 wherein a required test pressure for a first test side is different than a required test pressure for a second test side.

17. The non-transitory computer-readable medium of claim 13 wherein the first test sequence includes a step that causes a rated pressure of one of the components to be exceeded and wherein the second test sequence eliminates the step that causes the rated pressure to be exceeded.

18. The non-transitory computer-readable medium of claim 13 wherein the processor is further caused to:
receive a manual override request that alters a step of either test sequence such that the step causes a rated pressure of one of the components to be exceeded; and
as a result of a determination that the rated pressure is exceeded, cause a display device coupled to the processor to display a warning indication.
